(19) United States
(12) Patent Application Publication
(10) Pub. No.: US 2008/0024473 A1
(43) Pub. Date: Jan. 31, 2008

(54) Driving method and driving unit with timing controller

(76) Inventors: Ying-Hao Hsu, Tainan (TW); Hung-Yu Lin, Tainan (TW); Yu-Yeh Chen, Tainan (TW)

Correspondence Address: TROP PRUNER & HU, PC, 1616 S. VOSS ROAD, SUITE 750, HOUSTON, TX, 77057-2631, US

(21) Appl. No.: 11/881,609

(22) Filed: Jul. 27, 2007

(30) Foreign Application Priority Data
Jul. 28, 2006 (TW) 95127862

(51) Int. Cl. G06F 3/038

(52) U.S. Cl. 345/204

(57) ABSTRACT

A driving unit for a display device includes a buffer to provide first frame data and second frame data and a timing controller. The timing controller includes a first overdrive data generation unit responsive to the first frame data to output first overdrive frame data to the display device and a second overdrive data generation unit in response to the second frame data to output second overdrive frame data. The timing controller also includes a delay unit to delay the second current overdrive frame data by a delay time period to output the second current overdrive frame data to the display device after the delay time period.

### CROSS-REFERENCE TO RELATED APPLICATION

This claims the priority under 35 U.S.C. § 119 of Taiwan application No. 095127862, filed Jul. 28, 2006, which is incorporated herein by reference.

### TECHNICAL FIELD

The invention relates in general to a timing controller, and more particularly to a timing controller for reducing the reaction time of liquid crystal molecules.

### BACKGROUND

In a liquid crystal display (LCD) device with a refresh frequency of 60 Hz, each frame can be displayed for about 16.67 ms. To reduce the reaction time of liquid crystal molecules, a display device with a refresh frequency of 120 Hz can be used. By increasing the refresh frequency of the frames displayed in a display device, the charging frequency of the pixel electrode of each pixel unit in the display device is increased to enhance the reaction time of the liquid crystal molecules. To further increase the reaction speed of liquid crystal molecules, an overdrive technique can be applied in a display device with the refresh frequency of 120 Hz.

FIG. 1A illustrates two conventional 60 Hz frame data and several conventional 120 Hz frame data. A 60 Hz frame period T(n) is divided into two 120 Hz frame periods TS1(n) and TS2(n), as an example. According to the received 60 Hz frame data D(n) corresponding to a pixel, a timing controller of the LCD device generates 120 Hz frame data FD1(n) and FD2(n), which are displayed on an LCD device during the frame periods TS1(n) and TS2(n), respectively. Before the overdrive technique is applied, the 120 Hz frame data FD1(n) and FD2(n) are substantially the same and are equal to D(n).

After each 120 Hz frame period, the conventional timing controller determines if two adjacent 120 Hz frame data are equal to each other. If the two adjacent 120 Hz frame are not the same, then a 120 Hz overdrive (OD) data is used to replace the 120 Hz frame data. In FIG. 1A, the 120 Hz frame data FD1(n) is different from the 120 Hz frame data FD2(n−1). Therefore, the timing controller replaces the 120 Hz frame data FD1(n) with a 120 Hz overdrive frame data OD1(n) and outputs the overdrive frame data OD1(n) to a source driver in the LCD device. On the other hand, if the 120 Hz frame data FD1(n) and FD2(n) are the same, the timing controller outputs the 120 Hz frame data FD2(n) to the source driver. However, compared to the display device having a refresh frequency of 60 Hz, the time, so called charging time, that the overdrive voltage corresponding to the overdrive frame data OD1(n) remains on the pixel electrode is reduced in half when the refresh frequency of the frames is increased to 120 Hz. This is, the liquid crystal molecules of the pixel may not have enough time to react to reflect the correct transmittance of FD1(n). When the difference between the gray level values of two adjacent 120 Hz frame data is large, the reaction time of the liquid crystal molecules is increased because the time that the overdrive voltage remains on the pixel electrode is too short. As a result, the display quality may be poor.

FIG. 1B illustrates conventional gray level regions in which the reaction time of the liquid crystal molecules with the refresh frequency of 120 Hz is longer than that with the refresh frequency of 60 Hz. In FIG. 1B, the horizontal axis and the vertical axis represent the gray level value of the 60 Hz frame data D(n) and the gray level value of the 60 Hz frame data D(n−1), respectively. The regions 102 and 104 are the gray level regions in which the reaction time of the liquid crystal molecules with the refresh frequency of 120 Hz is longer than that with the refresh frequency of 60 Hz. When the reaction time of the liquid crystal molecules is increased, the pixels cannot reach the desired brightness, which can reduce display quality.

### BRIEF DESCRIPTION OF THE DRAWINGS

FIG. 1A illustrates two conventional 60 Hz frame data and several conventional 120 Hz frame data;

FIG. 1B illustrates conventional gray level regions in which the reaction time of the liquid crystal molecules with the refresh frequency of 120 Hz is longer than that with the refresh frequency of 60 Hz;

FIG. 2A is a block diagram of a liquid crystal display (LCD) device according to a first embodiment of the present invention;

FIG. 2B is a detailed block diagram of a driving unit in the LCD device of FIG. 2A;

FIG. 2C shows the relationship of frame periods of frame data in FIG. 2B;

FIG. 3 is a flow chart of a driving technique of the driving unit in FIG. 2A, according to an embodiment;

FIG. 4A is a block diagram of an LCD device according to a second embodiment of the present invention;

FIG. 4B is a detailed block diagram of a driving unit in the LCD device of FIG. 4A;

FIG. 5 is a flow chart of a driving technique of the driving unit in FIG. 4A, according to an embodiment;

FIG. 6A is a block diagram of a LCD device according to a third embodiment of the present invention;

FIG. 6B is a detailed block diagram of a driving unit in the LCD device in FIG. 6A;

FIG. 6C illustrates output frame data SO(n) of the driving unit in FIG. 6A when previous and current original frame data F(n) and F(n−1) are within a predetermined range; and

FIG. 6D illustrates the output frame data SO(n) of the driving unit in FIG. 6A when previous and current original frame data F(n) and F(n−1) are outside the predetermined range.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

In accordance with some embodiments, in response to an increase in refresh frequency of a liquid crystal display (LCD) device, a driving unit in the LCD device outputs at least one overdrive frame data to prolong the time that the overdrive voltage remains on a pixel electrode of the LCD device. The term “frame data” can refer to frame data used to drive a pixel. Alternatively, the term “frame date” can refer to data used to drive plural pixels. As a result, the issue that the display quality of the LCD device is affected by insufficient brightness of pixels can be addressed.

### FIRST EMBODIMENT

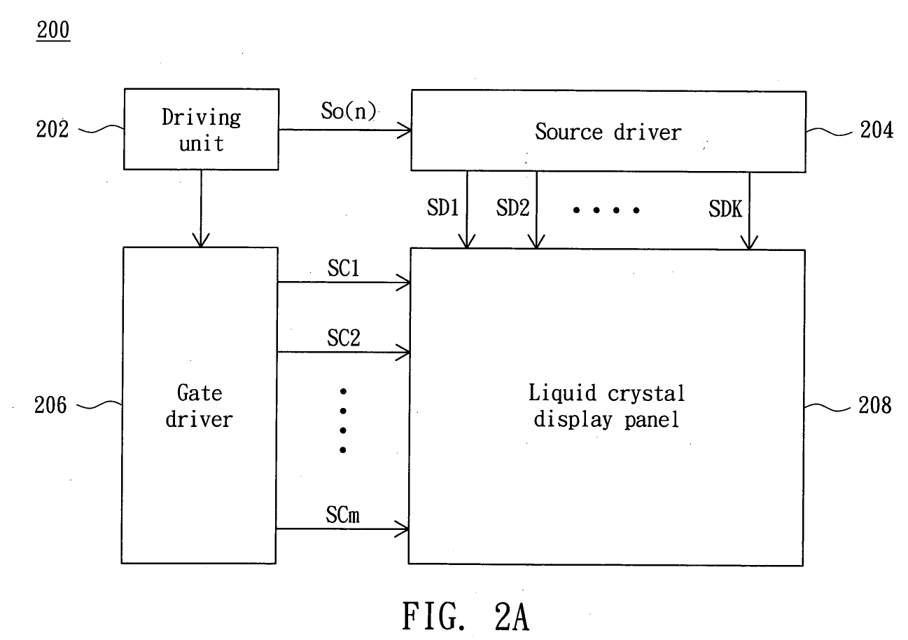

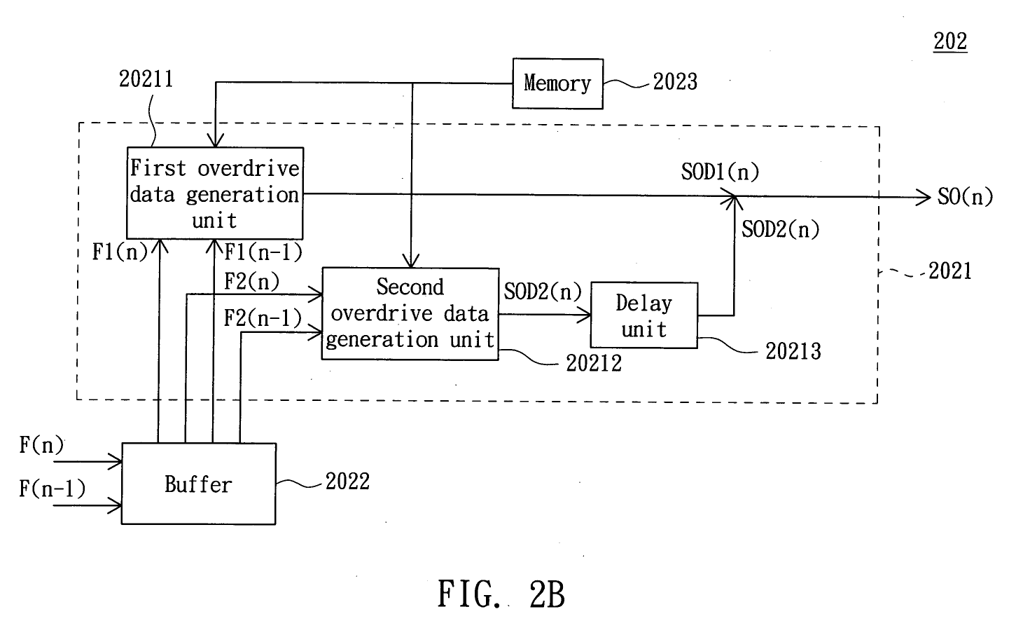

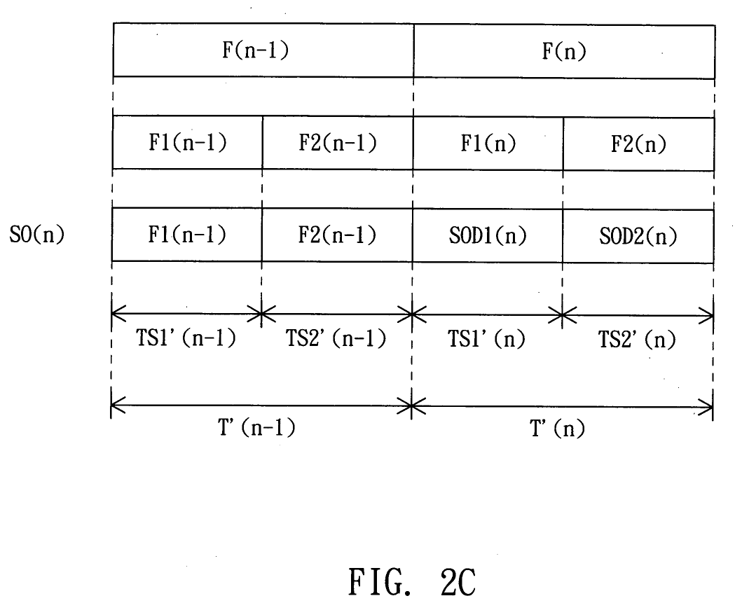

FIG. 2A is a block diagram of an LCD device 200 according to an embodiment. The LCD device 200 includes a driving unit 202, a source driver 204, a gate driver 206, and an LCD panel 208 that has an array of pixels, where each pixel has a pixel electrode and a thin-film transistor (TFT) to control the application of a data voltage to the pixel electrode. The driving unit 202 is coupled to the source driver 204 for outputting frame data SO(n) to the source driver 204. The source driver 204 outputs data signals SD1˜SDk according to the frame data SO(n) for driving pixels of the LCD panel 208. The gate driver 206 is coupled to the driving unit 202 and outputs scan signals Sc1˜Scm to the LCD panel 208 according to a clock signal (not shown in FIG. 2A) of the driving unit 202. Each scan line Sc can activate a row of TFTs in respective pixels. The variables k and m are integers greater than 1.

FIG. 2B is a detailed block diagram of the driving unit 202 in FIG. 2A. The driving unit 202 includes a buffer 2022, a timing controller 2021 and a memory 2023. The timing controller 2021 includes a first overdrive data generation unit 20211, a second overdrive data generation unit 20212, and a delay unit 20213. Outputs of the first overdrive data generation unit 20211 and the delay unit 20213 are coupled with each other for outputting the frame data SO(n).

The buffer 2022 is for storing a previous original frame data F(n−1) and a current original frame data F(n) corresponding to a pixel. The buffer 2022 provides a first previous adjusted frame data F1(n−1) and a second previous adjusted frame data F2(n−1) according to the previous original frame data F(n−1). Also, the buffer 2022 generates a first current adjusted frame data F1(n) and a second current adjusted frame data F2(n) according to the current original frame data F(n).

The first overdrive data generation unit 20211 receives the first previous adjusted frame data F1(n−1) and the first current adjusted frame data F1(n) and, in response, outputs a first current overdrive frame data SOD1(n) according to the first previous adjusted frame data F1(n−1), the first current adjusted frame data F1(n), and a first look-up table. The first look-up table maps inputs of F1(n−1) and F1(n) to an overdrive frame data value. This is, for each combination of F1(n−1) and F1(n), an overdrive frame data value could be consulted and outputted. The first overdrive data generation unit 20211 outputs the first current overdrive frame data SOD1(n) as the output frame data SO(n) to the source driver 204.

The second overdrive data generation unit 20212 receives the second previous adjusted frame data F2(n−1) and the second current adjusted frame data F2(n), and in response, outputs a second current overdrive frame data SOD2(n) according to the second previous adjusted frame data F2(n−1), the second current adjusted frame data F2(n), and a second look-up table. The second look-up table maps the difference between F2(n) and F2(n−1) with an overdrive frame data value. The delay unit 20213 receives the second current overdrive frame data SOD2(n) and delays the second current overdrive frame data SOD2(n). After a predetermined delay time period, the delay unit 20213 outputs the second current overdrive frame data SOD2(n) as the output frame data SO(n) to the source driver 204.

FIG. 2C depicts the relationship of the frame periods of the frame data in FIG. 2B. The frame periods of the previous and current original frame data F(n−1) and F(n) are T′(n−1) and T′(n), respectively. The frame periods of the first and second previous adjusted frame data F1(n−1) and F2(n−1) are TS1′(n−1) and TS2′(n−1), respectively. The frame periods of the first and the second current adjusted frame data F1(n) and F2(n) are TS1′(n) and TS2′(n), respectively. The length of the above-described predetermined delay time period is equal (or substantially equal) to the frame period TS1′(n). The length of each of the frame periods TS1′(n−1), TS2′(n−1), TS1′(n) and TS2′(n) can be equal to half of the frame period T′(n). The period of the output frame data SO(n) is equal (or substantially equal) to half of the frame period T′(n). In other words, the frequency of the output frame data SO(n) is twice as large as the frequency of the current original frame data F(n). However, in other embodiments, the period of SO(n) can be different.

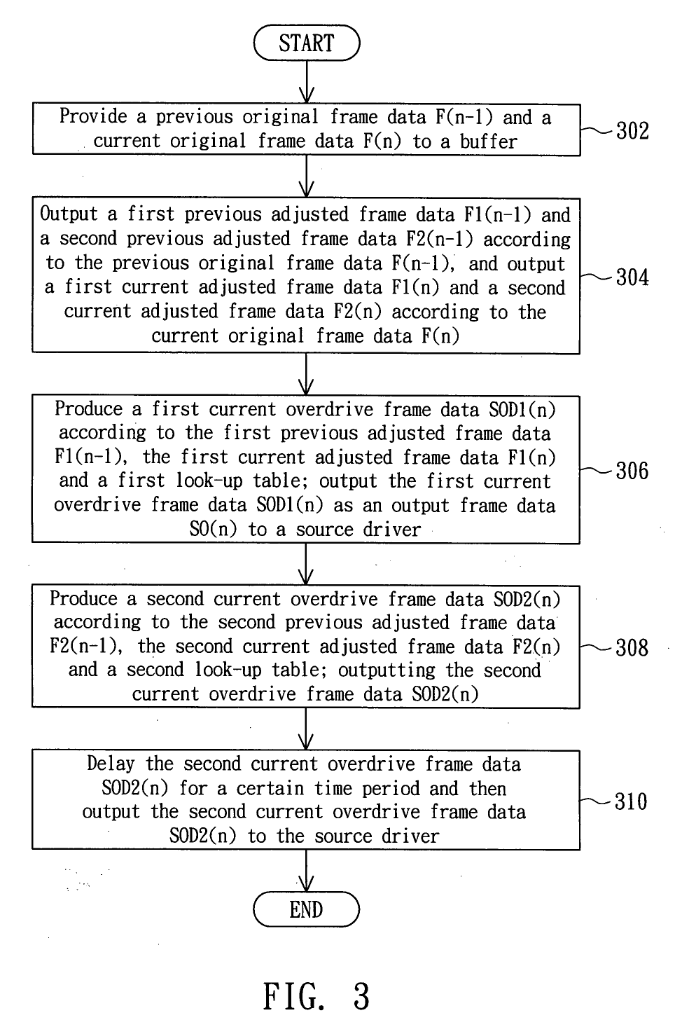

FIG. 3 is a flow chart of a driving technique of the driving unit 202 in FIG. 2A. First, in step 302, the previous original frame data F(n−1) and the current original frame data F(n) are provided to the buffer 2022. Next, in step 304, the first previous adjusted frame data F1(n−1) and the second previous adjusted frame data F2(n−1) are output according to the previous original frame data F(n−1), and the first current adjusted frame data F1(n), and the second current adjusted frame data F2(n) are output according to the current original frame data F(n).

Then, in step 306, the first current overdrive frame data SOD1(n) is produced according to the first previous adjusted frame data F1(n−1), the first current adjusted frame data F1(n), and the first look-up table. Also, the first current overdrive frame data SOD1(n) is output as the output frame data SO(n) to the source driver 204 (see row corresponding to SO(n) in FIG. 2C) in time period TS1′(n). Afterward, in step 308, the second current overdrive frame data SOD2(n) is produced according to the second previous adjusted frame data F2(n−1), the second current adjusted frame data F2(n), and the second look-up table. Later, in step 310, the second current overdrive frame data SOD2(n) is delayed for a predetermined delay time period and is then output as the output frame data SO(n) to the source driver 204.

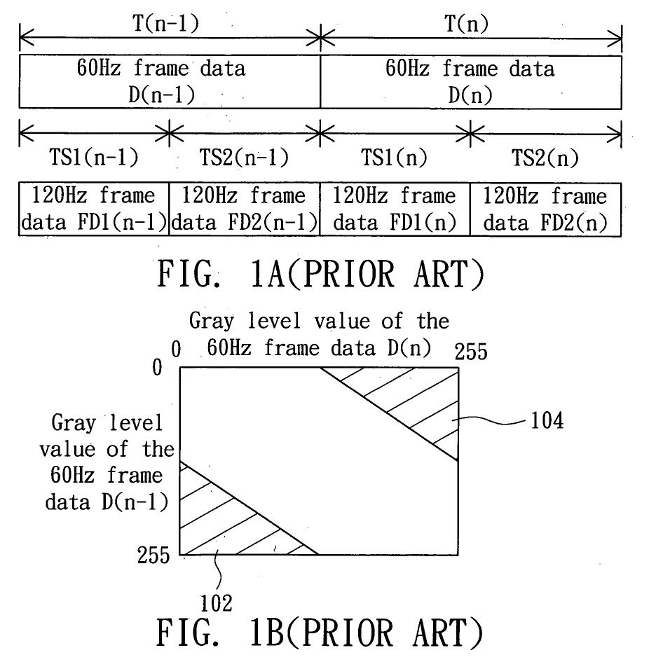

When the driving unit 202 of an embodiment doubles the frequency of the output frame data SO(n) (for example, the frequency is increased to 120 Hz from 60 Hz), the first and second current overdrive frame data SOD1(n) and SOD2(n) are output as the output frame data SO(n) to the source driver 204 during the frame periods TS1′(n) and TS2′(n), respectively. The time that the overdrive voltage corresponding to the output frame data SO(n), driven with SOD1(n) and SOD2(n) in the periods TS1′(n) and TS2′(n), respectively, remains on the pixel electrode is prolonged in accordance with an embodiment. Therefore, the issue of a pixel not reaching a target brightness due to a long reaction time of the liquid crystal molecules in the regions 102 and 104 in FIG. 1B can be addressed.

### SECOND EMBODIMENT

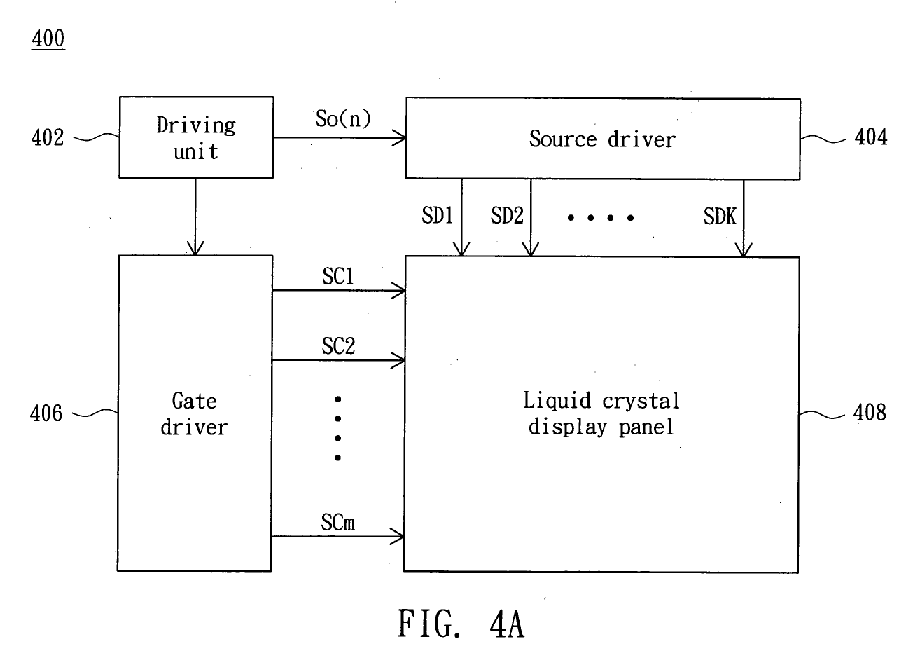

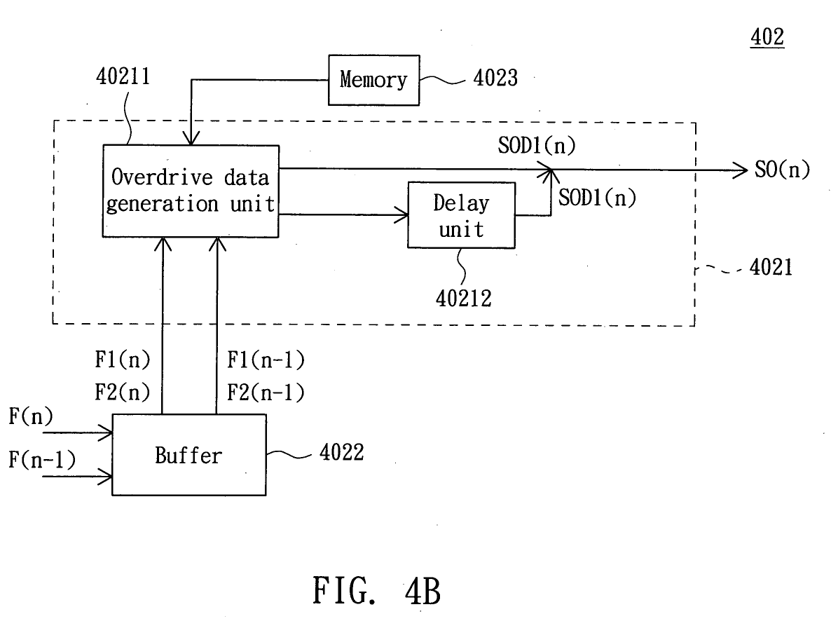

FIG. 4A is a block diagram of an LCD device 400 according to a second embodiment. FIG. 4B is a detailed block diagram of a driving unit 402 in FIG. 4A. The difference between the second embodiment and the first embodiment discussed above is that a driving unit 402 of the second embodiment includes only one overdrive data generation unit 40211. The LCD device 400 includes an LCD panel 408 driven by data lines SD1 to SDk from a source driver 404, and by scan lines SC1 to SCm from a gate driver 406. The source driver 404 and gate driver 406 are responsive to signals provided by the driving unit 402.

As shown in FIG. 4B, the driving unit 402 includes a buffer 4022 to receive F(n) and F(n−1). According to F(n) and F(n−1), the buffer 4022 produces F1(n), F2(n), F1 (n−1), and F2(n−1), which are provided to the overdrive data generation unit 40211. The overdrive output frame data SOD1(n) is provided both directly to SO(n), and through a delay unit 40212 to SO(n). The driving unit 402 also includes a memory 4023.

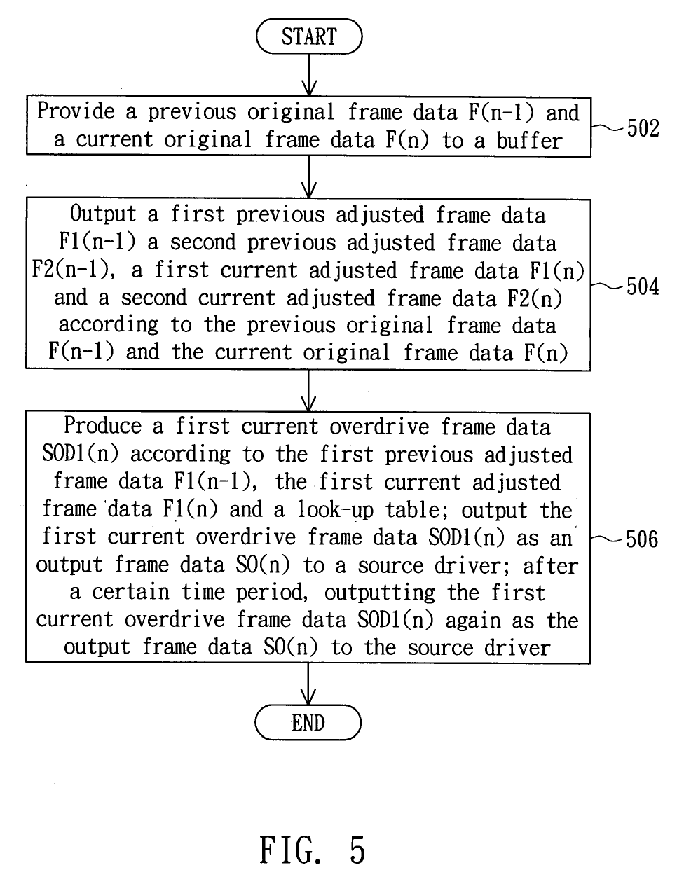

FIG. 5 is a flow chart of a driving technique of the driving unit 402 in FIG. 4A. First, in step 502, the previous original frame data F(n−1) and the current original frame data F(n) are provided to the buffer 4022. Next, in step 504, the first previous adjusted frame data F1(n−1), the second previous adjusted frame data F2(n−1), the first current adjusted frame data F1(n), and the second current adjusted frame data F2(n) are output according to the previous original frame data F(n−1) and the current original frame data F(n).

Then, in step 506, the first current overdrive frame data SOD1(n) is produced according to the first previous adjusted frame data F1(n−1), the first current adjusted frame data F1(n), and a look-up table. Also, the first current overdrive frame data SOD1(n) is output as the output frame data SO(n) to the source driver 404. After a predetermined delay time period, the first current overdrive frame data SOD1(n) is output again as the output frame data SO(n) to the source driver 404.

The driving unit 402 outputs the first current overdrive frame data SOD1(n) twice during the frame periods TS1′(n) and TS2′(n). As a result, even when the frequency of the output frame data SO(n) is twice as large as the frequency of the original frame data F(n), the time that the overdrive voltage corresponding to the output frame data SO(n) remains on the pixel electrode is prolonged.

### THIRD EMBODIMENT

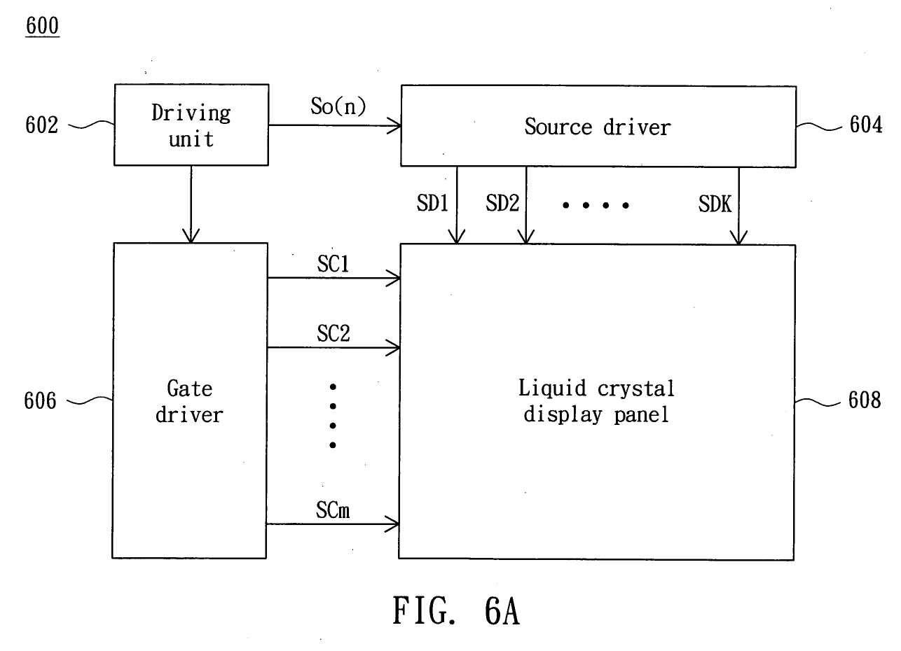

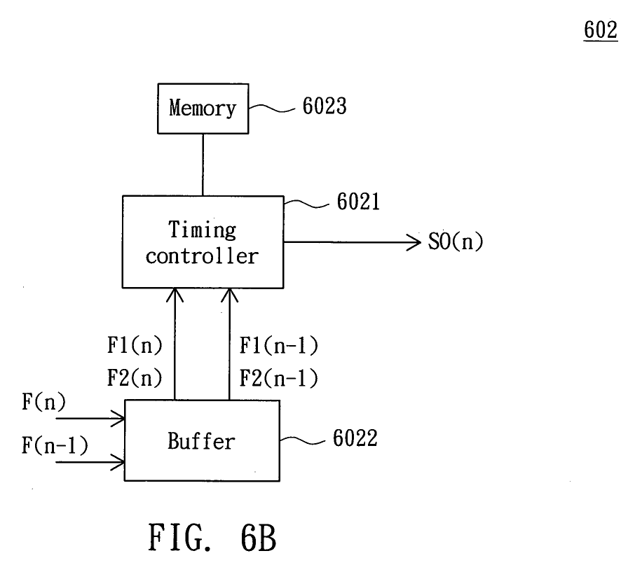

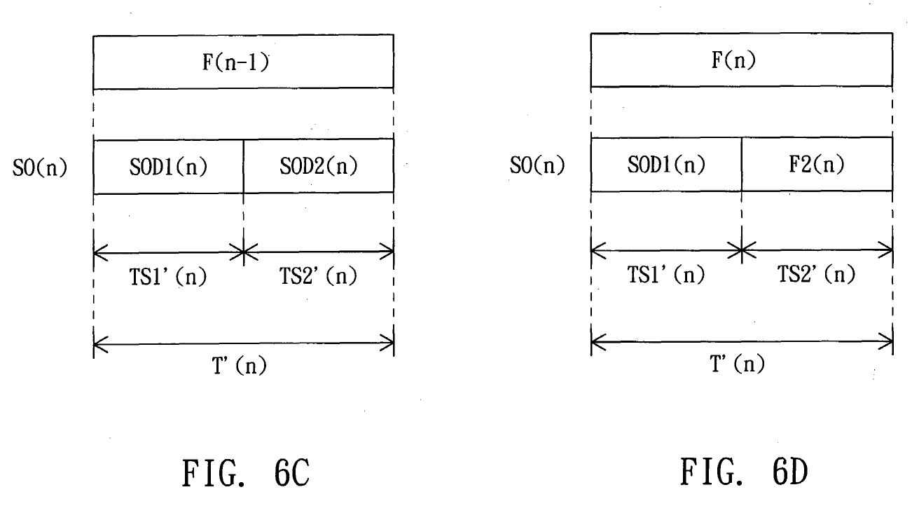

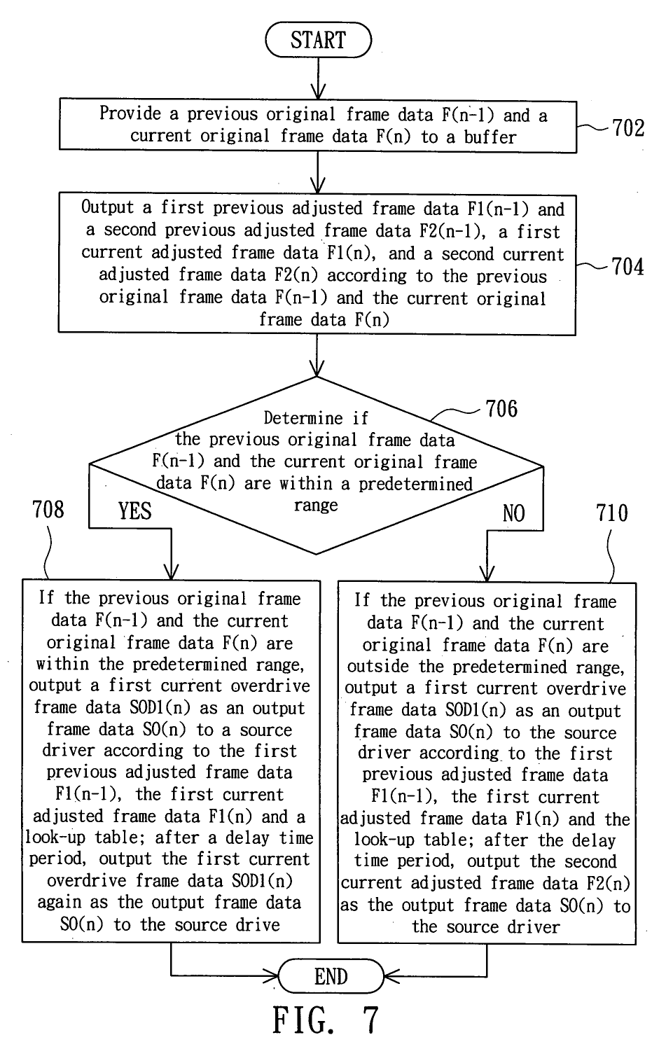

FIG. 6A is a block diagram of an LCD device 600 according to a third embodiment. FIG. 6B is a detailed block diagram of a driving unit 602 in FIG. 6A. The LCD device 600 includes an LCD panel 608 that is driven by data lines SD1 to SDk from a source driver 604, and driven by scan lines SC1 to SCm to scan by a gate driver 606. The source driver 604 and gate driver 606 are driven by signals from the driving unit 602.

FIG. 6C illustrates the output frame data SO(n) of the driving unit 602 in FIG. 6A when the previous and current original frame data F(n) and F(n−1) are within the predetermined range. FIG. 6D illustrates the output frame data SO(n) of the driving unit 602 in FIG. 6A when the previous and current original frame data F(n) and F(n−1) are outside the predetermined range (in other words, F(n) and F(n−1) is outside the predetermined range wherein the reaction time of the liquid crystal molecules with the refresh frequency of 120 Hz is longer than that with the refresh frequency of 60 Hz.).

The driving unit 602 includes a buffer 6022, a timing controller 6021, and a memory 6023. The difference between the third embodiment and the second embodiment is that the timing controller 6021 of the driving unit 602 in the third embodiment is able to determine if the previous original frame data F(n−1) and the current original frame data F(n) are within a predetermined range. The predetermined range can be the regions 102 or 104 in FIG. 1B.

When the previous original frame data F(n−1) and the current original frame data F(n) are within the predetermined range, the timing controller 6021 outputs the first current overdrive frame data SOD1(n) as the output frame data SO(n) in the period TS1′(n) to the source driver 604 according to the first previous adjusted frame data F1(n−1), the first current adjusted frame data F1(n), and a look-up table. After a predetermined delay time period, the timing controller 6021 outputs the first current overdrive frame data SOD1(n) in the time period TS1′(n) as the output frame data SO(n) again to the source driver 604. In other words, during the frame periods TS1′(n) and TS2′(n), the driving unit 602 outputs the first current overdrive frame data SOD1(n) twice as the output frame data SO(n) to the source driver 604.

As depicted in FIG. 6D, when the previous original frame data F(n−1) and the current original frame data F(n) are outside the predetermined range, the timing controller 6021 outputs the first current overdrive frame data SOD1(n) in time period TS1′(n) as the output frame data SO(n) to the source driver 604 according to the first previous adjusted frame data F1(n−1), the first current adjusted frame data F1(n), and the look-up table. After the predetermined delay time period, the timing controller 6021 outputs the second current adjusted frame data F2(n) in time period TS2′(n) as the output frame data SO(n) to the source driver 604. In other words, during the frame periods TS1′(n) and TS2′(n), the driving unit 602 outputs the first current overdrive frame data SOD1(n) and the second current adjusted frame data F2(n) as the output frame data SO(n) to the source driver 604.

For example, the timing controller 6021 determines if the previous original frame data F(n−1) and the current original frame data F(n) are within the predetermined range according to a data minimum deviation value. The timing controller 6021 compares the previous original frame data F(n−1) and the current original frame data F(n) to obtain a data deviation value (difference) of the previous original frame data F(n−1) and the current original frame data F(n). The timing controller 6021 compares the data deviation value and the data minimum deviation value. When the data deviation value is greater than or equal to the data minimum deviation value, the timing controller 6021 determines that the previous original frame data F(n−1) and the current original frame data F(n) are within the predetermined range. When the data deviation value is less than the data minimum deviation value, the timing controller 6021 determines that the previous original frame data F(n−1) and the current original frame data F(n) are outside the predetermined range. The data minimum deviation value is a predetermined parameter stored in the timing controller 6021.

FIG. 7 is a flow chart of a driving technique of the driving unit 602 in FIG. 6A. First, in step 702, the previous original frame data F(n−1) and the current original frame data F(n) are provided to the buffer 6022. Next, in step 704, according to the previous original frame data F(n−1) and the current original frame data F(n), the first previous adjusted frame data F1(n−1), the second previous adjusted frame data F2(n−1), the first current adjusted frame data F1(n) and the second current adjusted frame data F2(n) are output. Then, in step 706, it is determined if the previous original frame data F(n−1) and the current original frame data F(n) are within the predetermined range. Afterwards, in step 708, if the previous original frame data F(n−1) and the current original frame data F(n) are within the predetermined range, the first current overdrive frame data SOD1(n) is output as the output frame data SO(n) to the source driver 604 according to the first previous adjusted frame data F1(n−1), the first current adjusted frame data F1(n), and the look-up table. After the predetermined delay time period, the first current overdrive frame data SOD1(n) is output again as the output frame data SO(n) to the source driver 604.

On the other hand, in step 710, if the previous original frame data F(n−1) and the current original frame data F(n) are determined at 706 to be outside the predetermined range, the first current overdrive frame data SOD1(n) is output as the output frame data SO(n) to the source driver 604 according to the first previous adjusted frame data F1(n−1), the first current adjusted frame data F1(n), and the look-up table. After the predetermined delay time period, the second current adjusted frame data F2(n) is output as the output frame data SO(n) to the source driver 604.

The driving unit 602 of this embodiment determines if the previous and current original frame data F(n−1) and F(n) are within the predetermined range when the frequency of the output frame data SO(n) is doubled. If so, the driving unit 602 outputs the first current overdrive frame data SOD1(n) as the output frame data SO(n) during both the frame periods TS1′(n) and TS2′(n). As a result, even when the frequency of the output frame data SO(n) is twice as large as the frequency of the original frame data F(n), the time that the overdrive voltage corresponding to the output frame data SO(n) remains on the pixel electrode is prolonged in the case of the previous and the current original frame data F(n−1) and F(n) within the predetermined range. Thus, the issue of a pixel not being able to reach a desired brightness due to long reaction time of the liquid crystal molecules in the regions 102 and 104 in FIG. 1B can be addressed.

In the described embodiments, the memories 2023, 4023 and 6023 can be non-volatile memories such as electrically erasable read only memories (EEROM) or flash memories, for example. In the first embodiment, the memory 2023 is for storing the first look-up table and the second look-up table. In the second and the third embodiments, the memories 4023 and 6023 are for storing respective look-up tables.

In the above example embodiments, the frequency of the output frame data SO(n) is twice as high as the frequency of the current original frame data F(n). However, the operation of the driving units 202, 402 and 602 can be extended to other frequencies of the output frame data. The buffers 2022, 4022 and 6022 can be synchronous dynamic random access memory buffers (SDRAM buffer), for example.

In the first embodiment, the first current overdrive frame data SOD1(n) and the second current overdrive frame data SOD2(n) can be the same (or substantially the same) or different. For example, the first current overdrive frame data SOD1(n) can be a low driving overdrive frame data. In other words, the gray level value of the first current overdrive frame data SOD1(n) can be less than that of the second current overdrive frame data SOD2(n).

The driving unit of some embodiments the present invention provides two overdrive frame data during one frame period. Alternatively, the driving unit selectively provides two overdrive frame data during one frame period. The time that the overdrive voltage corresponding to the output frame data SO(n) remains on the pixel electrode is prolonged in some embodiments. As a result, the reaction speed of liquid crystal molecules is increased for the data corresponding to all the gray level values when the refresh frequency is doubled. The frame can be displayed quickly and correctly, and the display quality is improved.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A driving unit for a display device, comprising:
a buffer to provide first frame data and second frame data; and
a timing controller comprising:
a first overdrive data generation unit responsive to the first frame data to output first overdrive frame data to the display device;
a second overdrive data generation unit responsive to the second frame data to output a second overdrive frame data; and
a delay unit to delay the second current overdrive frame data by a delay time period, and to output the second current overdrive frame data to the display device after the delay time period.

2. The driving unit of claim 1, the buffer is to store previous original frame data and current original frame data and to generate first previous adjusted frame data and second previous adjusted frame data according to the previous original frame data, and
the buffer to generate first current adjusted frame data and second current adjusted frame data according to the current original frame data,
wherein the first frame data comprises the first previous adjusted frame data and the first current adjusted frame data, and the second frame data comprises the second previous adjusted frame data and the second current adjusted frame data.

3. The driving unit according to claim 2, wherein a frame period of the first current adjusted frame data and a frame period of the second current adjusted frame data are substantially equal to half of a frame period of the current original frame data, a length of the delay time period being substantially equal to the frame period of the first current adjusted frame data.

4. The driving unit according to claim 2, wherein the first overdrive data generation unit generates the first overdrive frame data according to the first previous adjusted frame data, the first current adjusted frame data, and a first look-up table, and
wherein the second overdrive data generation unit generates the second overdrive frame data according to the second previous adjusted frame data, the second current adjusted frame data, and a second look-up table.

5. The driving unit according to claim 4, further comprising:
a non-volatile memory for storing the first look-up table and the second look-up table.

6. The driving unit according to claim 2, wherein the first previous adjusted frame data and the second previous adjusted frame data are substantially the same, and the first current adjusted frame data and the second current adjusted frame data are substantially the same.

7. A display device comprising:
a display panel;
a driving unit comprising:
a buffer to store previous original frame data and current original frame data and to generate first previous adjusted frame data and second previous adjusted frame data according the previous original frame data, the buffer to generate first current adjusted frame data and second current adjusted frame data according to the current original frame data; and
a timing controller comprising:
a first overdrive data generation unit to receive the first previous adjusted frame data and the first current adjusted frame data, and to output first current overdrive frame data according to the first previous adjusted frame data, the first current adjusted frame data, and a first look-up table;
a second overdrive data generation unit to receive the second previous adjusted frame data and the second current adjusted frame data, and to output second current overdrive frame data according to the second previous adjusted frame data, the second current adjusted frame data, and a second look-up table; and
a delay unit to receive the second current overdrive frame data, delay the second current overdrive frame data for a delay time period, and then to output the second current overdrive frame data; and
a data driver coupled to the driving unit and the display panel, the data driver to receive the first and second current overdrive frame data and to drive the display panel according to the first and second current overdrive frame data.

8. The display device according to claim 7, wherein a frame period of the first current adjusted frame data and a frame period of the second current adjusted frame data are substantially equal to half of a frame period of the current original frame data, the length of the delay time period being substantially equal to a frame period of the first current adjusted frame data.

9. The display unit according to claim 7, wherein the first previous adjusted frame data and the second previous adjusted frame data are substantially the same, and the first current adjusted frame data and the second current adjusted frame data are substantially the same.

10. A driving unit for a display device, comprising:
a buffer to store previous original frame data and current original frame data and to generate first previous adjusted frame data and second previous adjusted frame data according to the previous original frame data, the buffer to generate first current adjusted frame data and second current adjusted frame data according to the current original frame data; and
a timing controller to determine if the previous original frame data and the current original frame data are within a predetermined range, and if so, to output first current overdrive frame data to the display device according to the first previous adjusted frame data, the first current adjusted frame data, and a look-up table, and to output the first current overdrive frame data again to the display after a delay time period;
in response to the previous original frame data and the current original frame data not being within the predetermined range, the timing controller to output the first current overdrive frame data to a source driver of the display device according to the first previous adjusted frame data, the first current adjusted frame data, and the look-up table, and to output the second current adjusted frame data to the display after the delay time period.

11. The driving unit according to claim 10, wherein the timing controller determines if a difference of the previous original frame data and the current original frame data is greater than or equal to a predetermined deviation value; if the difference is greater than or equal to the predetermined deviation value, the previous original frame data and the current original frame data are within the predetermined range; if the difference is less than the predetermined deviation value, the previous original frame data and the current original frame data are outside the predetermined range.

12. A display device comprising:
a display panel;
a driving unit comprising:
a buffer to store previous original frame data and current original frame data and to generate first previous adjusted frame data and second previous adjusted frame data according the previous original frame data, the buffer to generate first current adjusted frame data and second current adjusted frame data according to the current original frame data; and
a timing controller to determine if the previous original frame data and the current original frame data are within a predetermined range, and if so, to output first current overdrive frame data to the display device according to the first previous adjusted frame data, the first current adjusted frame data, and a look-up table, and to output the first current overdrive frame data again after a delay time period;
in response to the previous original frame data and the current original frame data not being within the predetermined range, the timing controller to output the first current overdrive frame data according to the first previous adjusted frame data, the first current adjusted frame data, and the look-up table, and to output the second current adjusted frame data after a certain time period; and
a data driver coupled to the driving unit and the display panel, the data driver to receive the first current overdrive frame data and the second current adjusted frame data, the data driver to drive the display panel according to the first current overdrive frame data and second current adjusted frame data.

13. The display according to claim 12, wherein the timing controller determines if a difference of the previous original frame data and the current original frame data is greater than or equal to a predetermined deviation value; if the difference is greater than or equal to the predetermined deviation value, the previous original frame data and the current original frame data are within the predetermined range; if the difference is less than the predetermined deviation value, the previous original frame data and the current original frame data are outside the predetermined range.

14. The display device according to claim 12, wherein the driving unit further comprises:
a non-volatile memory to store the look-up table.

15. A driving unit for a display device, comprising:
a buffer to store previous original frame data and current original frame data and to generate first previous adjusted frame data and second previous adjusted frame data according to the previous original frame data, the buffer to generate first current adjusted frame data and second current adjusted frame data according to the current original frame data; and
a timing controller comprising:
an overdrive data generation unit to receive the first previous adjusted frame data and the first current adjusted frame data and to output first current overdrive frame data to the display device according to the first previous adjusted frame data, the first current adjusted frame data, and a look-up table; and
a delay unit to receive the first current overdrive frame data and to output the first current overdrive frame data to the display device again after a delay time period.

16. A driving unit according to claim 15, wherein a frame period of the first current adjusted frame data and a frame period of the second current adjusted frame data are substantially equal to half of a frame period of the current original frame data, a length of the delay time period being substantially equal to the frame period of the first current adjusted frame data.

17. The driving unit according to claim 15, wherein the first previous adjusted frame data and the second previous adjusted frame data are substantially the same, and the first current adjusted frame data and the second current adjusted frame data are substantially the same.

18. A display device comprising:
a display panel;
a driving unit comprising:
a buffer to store a previous original frame data and current original frame data to generate first previous adjusted frame data and second previous adjusted frame data according the previous original frame data, the buffer to generate first current adjusted frame data and second current adjusted frame data according to the current original frame data; and
a timing controller comprising:
an overdrive data generation unit to receive the first previous adjusted frame data and the first current adjusted frame data, and to output first current overdrive frame data to the display device according to the first previous adjusted frame data, the first current adjusted frame data, and a look-up table; and
a delay unit to receive the first current overdrive frame data, and to output the first current overdrive frame data to the display device again after a delay time period; and
a data driver coupled to the driving unit and the display panel, the data driver to receive the first current overdrive frame data and to drive the display panel according to the first current overdrive frame data.

19. A driving method for a display device, the display device comprising a source driver and a driving unit, the driving unit comprising a buffer and a timing controller, the timing controller comprising a first overdrive data generation unit, a second overdrive data generation unit and a delay unit, the driving method comprising:
providing previous original frame data and current original frame data to the buffer;
outputting first previous adjusted frame data and second previous adjusted frame data according to the previous original frame data, and outputting first current adjusted frame data and second current adjusted frame data according to the current original frame data;
outputting first current overdrive frame data to the source driver according to the first previous adjusted frame data, the first current adjusted frame data, and a first look-up table;
outputting second current overdrive frame data according to the second previous adjusted frame data, the second current adjusted frame data, and a second look-up table; and
delaying the second current overdrive frame data for a delay time period and, after the delay time period, outputting the second current overdrive frame data to the source driver.

20. The method according to claim 19, wherein a frame period of the first current adjusted frame data and a frame period of the second current adjusted frame data are substantially equal to half of a frame period of the current original frame data, a length of the delay time period being substantially equal to the frame period of the first current adjusted frame data.

21. The method according to claim 19, wherein the first previous adjusted frame data and the second previous adjusted frame data are substantially the same, and the first current adjusted frame data and the second current adjusted frame data are substantially the same.

22. The method according to claim 19, wherein the current original frame data is associated with a frame period that has a first sub-period and a second sub-period,
wherein the first current overdrive frame data is output during the first sub-period, and
wherein the second current overdrive frame data is output during the second sub-period.

23. A driving method for a display device, the display device comprising a source driver and a driving unit, the driving unit comprising a buffer and a timing controller, the driving method comprising:
providing previous original frame data and current original frame data to the buffer;
outputting first previous adjusted frame data and second previous adjusted frame data according to the previous original frame data, and outputting first current adjusted frame data and second current adjusted frame data according to the current original frame data;
determining if the previous original frame data and the current original frame data are within a predetermined range; and
in response to the previous original frame data and the current original frame data being within the predetermined range outputting a first current overdrive frame data to the source driver according to the first previous adjusted frame data, the first current adjusted frame data, and a look-up table; and
outputting the first current overdrive frame data again to the source driver after a delay time period.

24. The method according to claim 23, further comprising:
in response to the previous original frame data and the current original frame data being outside the predetermined range, outputting the first current overdrive frame data to the source driver according to the first previous adjusted frame data, the first current adjusted frame data, and the look-up table, and outputting the second current adjusted frame data to the source driver after the delay time period.

25. The method according to claim 23, the timing controller determining if the previous original frame data and the current original frame data are within the predetermined range by comparing a difference between the previous original frame data and the current original frame data to a predetermined deviation value; if the difference is greater than or equal to the predetermined deviation value, the previous original frame data and the current original frame data are within the predetermined range; and if the difference is less than the predetermined deviation value, the previous original frame data and the current original frame data are outside the predetermined range.

26. A driving method for a display, the display comprising a source driver and a driving unit, the driving unit comprising a buffer and a timing controller, the method comprising:
providing previous original frame data and current original frame data to the buffer;
outputting a first previous adjusted frame data and a second previous adjusted frame data according to the previous original frame data;
outputting a first current adjusted frame data and a second current adjusted frame data according to the current original frame data;
outputting a first current overdrive frame data to the source driver according to the first previous adjusted frame data, the first current adjusted frame data, and a look-up table; and
outputting the first current overdrive frame data to the source driver again after a delay time period.
